(19) United States
(12) Patent Application Publication
(10) Pub. No.: US 2017/0034581 A1
(43) Pub. Date: Feb. 2, 2017

(54) MEDIA DEVICE

(71) Applicant: Microsoft Technology Licensing, LLC, Redmond, WA (US)

(72) Inventors: Theo Colin Short, London (GB); Jaanus Soots, Tallinn (EE); Rama Kurvakat, London (GB); Vijay Ramdas, London (GB)

(21) Appl. No.: 14/849,256

(22) Filed: Sep. 9, 2015

(30) Foreign Application Priority Data
Jul. 27, 2015 (GB) 1513196.4

(51) Int. Cl. H04N 21/475; H04N 21/84; H04N 21/2543; H04N 21/4627; H04N 21/4788; H04N 21/488; H04N 21/41; H04N 21/254

(52) U.S. Cl. CPC H04N 21/4755; H04N 21/4126; H04N 21/84; H04N 21/2541; H04N 21/4627; H04N 21/4788; H04N 21/4882; H04N 21/2543

(57) ABSTRACT

A portion of media content being outputted to a user by a media device is identified as follows. A user input is received from the user at the media device during the outputting of the media content. The user input denotes a current interest in the media content expressed by the user. An identifier of a portion of the media content corresponding to a timing of the user input is identified by the media device. The identifier is for locating associated content information held in a content identification database. In response to the user input, the media device uses the identifier to render accessible, to a secondary device available to the user, the associated content information.

### RELATED APPLICATION

This application claims priority under 35 USC 119 or 365 to Great Britain Application No. 1513196.4 filed Jul. 27, 2015, the disclosure of which is incorporated by reference in its entirety.

### BACKGROUND

Increasingly, dedicated media devices such as televisions (TVs), television set-top boxes and games consoles are being equipped with enhanced functionality. In particular, such devices are being equipped with network connectivity and processing capabilities which allow them to run third-party software applications (or “apps”) on the device's native operating system. An app may be provided with the television, or downloaded by the media device from a network such as the Internet at the behest of a user of the device. Televisions incorporating such advanced functionality are often referred to as “smart TVs”.

These advanced capabilities include the integration of communication client software into such devices to enable communications within a communications system, which may include a packet-based communications network such as the Internet over which the communications are conducted. Among other things, the embedding of a packet-based communication client in such media allows a large, high-resolution display (e.g. a TV screen integrated into a smart TV, or an external screen connected to a games console or set-top box) to be utilised for video calling. Furthermore, significant processing power can be provided in the TV, particularly as the power requirements for a large, mains electricity powered consumer electronics device are less stringent than, for example mobile devices. This can enable a full range of features to be included in the embedded communication client, such as high quality voice and video encoding.

Such communication systems include voice or video over internet protocol (VoIP) systems. These systems are beneficial to the user as they are often of significantly lower cost than conventional fixed line or mobile cellular networks. This may particularly be the case for long-distance communication. The client software sets up the VoIP connections as well as providing other functions such as registration and user authentication based on, say, login credentials such as a username and associated password. This allows user-authenticated access to an Internet backend in order to provide access to a user's account. Authenticating a user may involve entering the login credentials at the media device using, for example, a standard TV remote control or game controller and an on-screen graphical User Interface (UI) keyboard. Once logged in, the media device can access the user's account data stored at the backend such as their contact list, conversation history, notifications, preferences, and presence data (which can, for example, be updated to notify other users of the system that the user is now online) among others.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A portion of media content being outputted to a user by a media device is identified as follows. A user input is received from the user at the media device during the outputting of the media content. The user input denotes a current interest in the media content expressed by the user. An identifier of a portion of the media content corresponding to a timing of the user input is identified by the media device. The identifier is for locating associated content information held in a content identification database, and may for example comprise.

In response to the user input, the media device uses the identifier to render accessible, to a secondary device available to the user, the associated content information.

There are a number of ways in which the media device can use the identifier to make the associated information accessible to the secondary device. For example, in various embodiments it may do this by:
retrieving the associated information from the content identification database using the identifier, and transmitting the retrieved information to the secondary device and/or a remote memory location accessible to it; or by transmitting the identifier to some other computer device, such as a server, so as to cause it to perform equivalent retrieving and transmitting operations on behalf of the media device;
transmitting the identifier to the secondary device and/or to a remote memory location accessible to it, so that the secondary device itself can access retrieve the associated content information from the content identification database using the identifier.

### BRIEF DESCRIPTION OF FIGURES

For a better understanding of the present subject matter, and to show how the same may be carried into effect, reference is made by way of example to the following figures in which:

FIG. 1 shows a block diagram of a communication system;

FIG. 2 shows a function block diagram of a media device;

FIGS. 3A-3D show operations performed at various stages during the outputting of media content by a media device;

FIG. 4 shows various graphical user interfaces presented by a communication client application.

### DETAILED DESCRIPTION OF EMBODIMENTS

As indicated above, a portion of the media content being outputted to the user by a media device is identified by the media device itself; however, associated content information about the identified portion is communicated to a separate, secondary device in response to a user input at the media device.

In other words, if and when the content being consumed by the user sparks their interest, they can engage with the content using the media device itself (by supplying the user input); however, the associated content information they obtain from this engagement is made accessible to the separate, secondary device. This is beneficial for the user, as they can obtain the associated content information on the secondary device—which is generally a more convenient place for it—without having to have the secondary device to hand when consuming the content. Moreover, even if they do happen have the secondary device to hand, there is no need for the secondary device to be constantly running specialist companion software whilst the content is viewed, in contrast to existing “second screen” technologies.

The desired information—i.e. the identifier of the portion of media content and/or the associated content information—may be stored, either at the secondary device or a remote memory location accessible to the secondary device via the network, for later use at a time of the user's choosing. For example, the user can wait go back to it when they have finished consuming the content, so as not to disrupt their content consuming experience.

Where the desired information is stored to a remote memory location, the secondary device does not need to be in communication with the media device during the outputting of the media content (e.g. it may be powered of or in some other disconnected state) as it is can connect to the network at a later time to retrieve the desired information from the remote memory location.

Some existing mechanisms allow a user to engage with content outputted by a media device using the media device itself. An example is the “red button” service provided by some digital television broadcasters, whereby a red button icon is displayed at certain points in the outputting of television broadcast content. The user can then press a red button on the TV remote control to obtain information about the current content, which is displayed on the TV itself. This is sub-optimal, as TV user interfaces tend to be relatively cumbersome and unintuitive. Displaying the content information on the TV also disrupts the user's viewing experience. Moreover, the information is only available for as long as the red button icon is displayed.

Other existing mechanisms for engaging with content provide a so-called “second screen” experience on a secondary companion device in the form of a smartphone or tablet. These allow a user to engage with the media content using a companion application executed on the companion device. However, to engage with the content, the user has to use the companion device itself to do so, by inputting user inputs to the companion device. This mean they have to have the companion device to hand when consuming the media content, which is inconvenient for the user. Moreover, existing second screen technologies require the companion application to be constantly running on the companion device in the background whilst the media content is being outputted. This is resource intensive, not least because existing second screen apps tend identify the outputted content by continuously monitoring its audio data, using a microphone of the companion device, which requires significant processing resources. This, in turn, results in faster battery drain of the smartphone or tablet (among other things).

None of these existing mechanisms allow a user to make available content information on a secondary device by inputting a user input to a media device that is outputting the content.

The user input of the present subject matter may, for example, be effected by the user pressing a button on a control apparatus of the media device—such as a remote control, games console, keyboard, mouse, trackpad etc.—or using some other input mechanism of the control apparatus. As another example, the user input may be inputted via a “natural” user interface (NUI) provided by the media device. An NUI enables the user to interact with a device in a natural manner, free from artificial constraints imposed by certain input devices such as mice, keyboards, remote controls, and the like. Examples of NUI methods include those utilizing touch sensitive displays, voice and speech recognition, intention and goal understanding, motion gesture detection using depth cameras (such as stereoscopic or time-of-flight camera systems, infrared camera systems, RGB camera systems and combinations of these), motion gesture detection using accelerometers/gyroscopes, facial recognition, 3D displays, head, eye, and gaze tracking, immersive augmented reality and virtual reality systems etc.

The associated content information may, for example, identify an object, person, organization or other entity appearing in and/or described by the portion of media content in which the user has expressed an interest; for example, it may comprise a name, telephone number or any other suitable identifier of the entity. The portion may for example be a scene of a film or television program, or other discernible section of video content such as an advertisement, in which the entity is visible or described. Alternatively or in addition, the associated content information may comprise more general information about the entity, such as a type of the entity (e.g. identifying it as a particular type of organization, such as a particular charity or business).

In certain embodiments, a login mechanism is used to share the content attribute information with the secondary device, as this can be a convenient mechanism. A software application running on the media device logs into a remote computer system using a certain set of login credentials provided by the user, so as to gain access to the remote memory location to which the desired information is transmitted. An application running on the secondary device can then the desired information held at the remote memory location when it is logged to the remote computer system using the same set of credentials. In some embodiments, the applications are communication client applications (e.g. VoIP clients) for effecting communication events (e.g. VoIP calls) within a communication system. In this case, existing login infrastructure provided within the communication system can be conveniently exploited to this end.

To aid illustration, consider following examples.

### Example 1

The user is watching TV when an advertisement is shown during a commercial break by a pizza company. The TV identifies the type of product (pizza) and the company automatically. The user likes the look of the pizza company, so they select an option at the TV to flag the current content i.e. to obtain additional information about it using the TV remote. In response, the TV transmits content information, identifying the company and the product, to the user's mobile device or a remote location accessible to it. There is no need for the user to have their mobile available to them at this point.

At a later time, a software application running on the mobile device can then present, based on the content information, options to purchase the pizza, call the business, view a menu; or information about alternative businesses offering similar products etc.

### Example 2

The user is watching TV and sees that a charity is appealing for donations. The appeal is effective, as it prompts the user to consider making a donation. The user selects the like option at the TV, which causes the TV to transmit content information, relating to the charity, to the user's mobile device or a remote location accessible to it.

At a later time of his choosing, the user can donate to the charity via using the mobile device, using payment options provided by the client application running on the mobile device (e.g. Skype credit). The user can also share information about the charity with his contacts in the communications system (e.g. family and friends) using the client application on the mobile device.

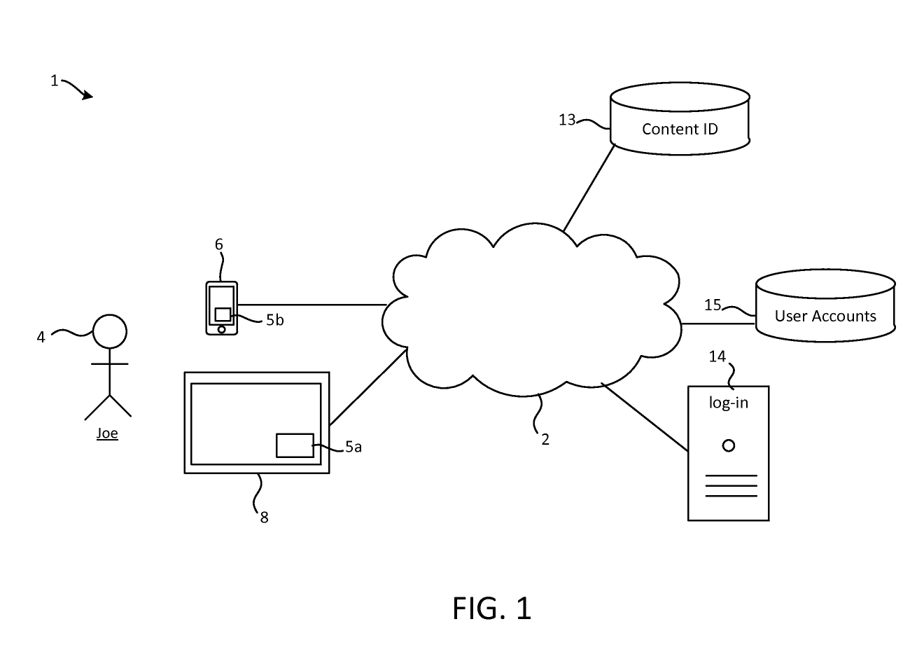

FIG. 1 shows a schematic block diagram of a communication system 1. The communication system 1 comprises a communications network 2, which is a packet-based computer network such as the Internet. Connected to the network 2 are a media device 6 and secondary device 8 of the user 2; a remote user account computer system 14 formed of one or more server devices; a user account database 15; and a content identification database 13.

Each of the databases 13, 15 comprises computer storage, and at least one processor (e.g. of a database server) executing database management code to provide access to the computer storage.

The media device 8 outputs media content to the user, in particular audiovisual (AV) content comprising both audio and video data. The media device 8 is a computer device and for example take the form of a dedicated media device whose primary function is the outputting of AV content such a smart TV, set top box or games console etc. As another example, the media device 8 may take the form of a general-purpose computer device, such as a laptop or desktop computer, capable of outputting AV content.

The secondary device 6 is a separate computer device and may for example take the form of a mobile device (e.g. smartphone), tablet, laptop or desktop computer device etc.

The secondary device 6 and media device 8 are each configured to execute a version 5a, 5b of a communication client. The communication client is executable code which enables the device 6, 8 on which it is executed to establish real-time communication events (such as real-time voice or video calls, instant messaging sessions, screen sharing or whiteboard sessions, etc.), via the network 2, with other users of the communication system 1 operating their own devices running communication client software (not shown). Call audio and/or video is transmitted and received over the network 2 during an established call. The communication is “real-time” in the sense in that there is only a short delay, for instance about 2 second or less, between audio/video being captured at a near-end device and received and outputted by a far-end device. The client may for example be a stand-alone software application that is executed on a processor of the relevant device and runs on top of an operating system, or a plugin to another application executed on the processor such as a Web browser.

The devices 6, 8 may have different operating systems, and in this case execute different versions 5a, 5b of the communication client i.e. each device 6,8 executes a version 5a, 5b of the client that is adapted for execution on that device's operating system (OS).

The remote user account computer system 14 grants access to the user account database 15, so that the user's user account information held the user account database 15 is accessible to the user devices 6, 8 via the network 2 and remote computer system 14 when the devices 6, 8 are logged in to the remote computer system 14 using the user's login credentials, such as their username and password. That it, when logged in in this manner, both devices 6, 8 are can access and update the user's user account data that is held in the user account database 15, and in some cases can authorize other devices (such as another server) to access or update this information on their behalf.

The user's user account data includes address book data, identifying the user's contacts within the communication system 1; historic communication event data, recording previous communication events that the user 2 has conducted within the communication system 1; details of the user (i.e. personal information) which they have registered within the communication system 1, such as their name, email address, postal address, telephone number etc.

The content identification database 13 holds various sets of content information, relating to different temporal points in the media content outputted by the media device 8 to the user 4. Each set of content information is held in association with a respective identifier of a portion of the media content to which it relates (“content identifier”). When a target content identifier of a particular portion of the media content is received at the database 13, database management code executed on a processor of the database 13 (not shown) compares the target identifier with the content identifiers stored in the database 13 to locate a matching content identifier in the database, and retrieves the set of content information associated with the matching identifier.

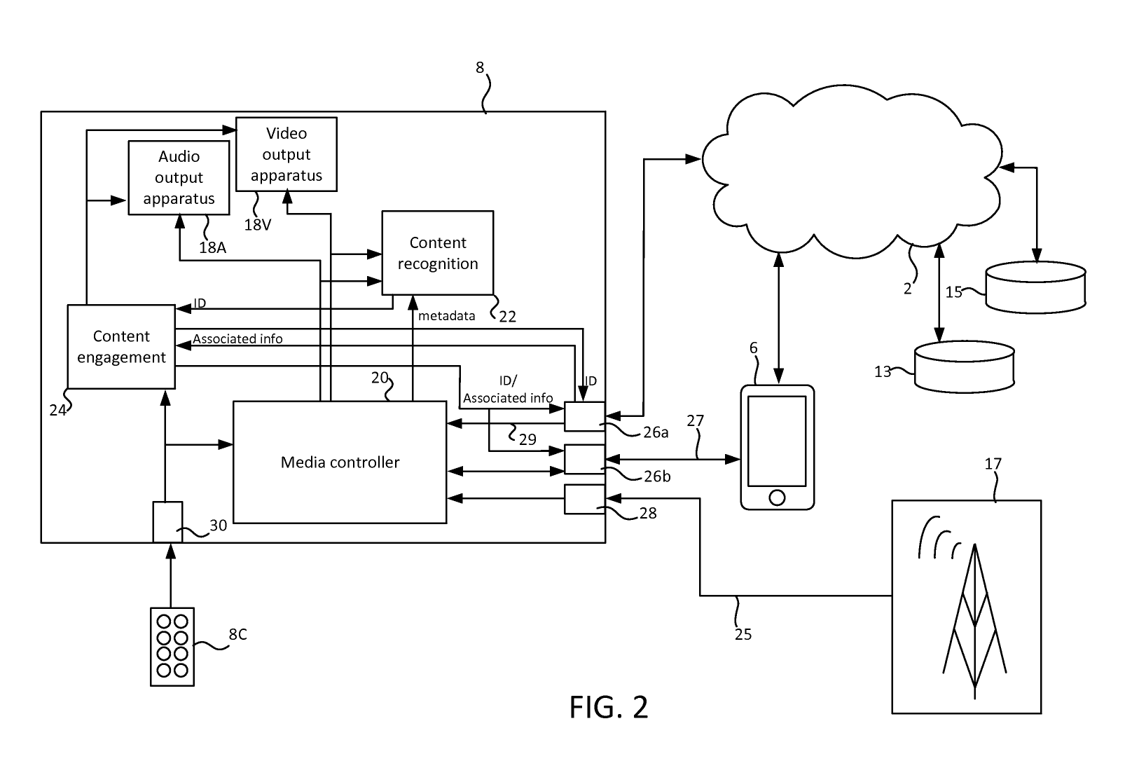

FIG. 2 shows a schematic block diagram of the media device 8. In this example, the media device 8 is a TV device capable of receiving and outputting broadcast television content from a television broadcaster 17, such as a smart TV, television set-top box, games console or other computer device (e.g. laptop, desktop) equipped with such TV functionality.

The media device comprises the following functional modules: a media controller 20, a content recognition module 22 and a content engagement module 24. The media device 8 also comprises: media apparatus, in the form of audio and video apparatus 18A, 18B; a network interface 26a via which the media device 8 is connected to the network 2 based on wired (e.g. Ethernet) and/or wireless (e.g. Wi-Fi) communications technology; and an AV interface 28 configured to receive AV content from a television broadcaster 17 (typically this is received in digital form nowadays, though the possibility of it being received in analogue form is not excluded).

In this example, the media device 8 also comprises a control interface 30 and a short-range wireless interface 26b.

The wireless interface 26b is configured to provide a communications link 27 between the media device 6 and the secondary device 6 when the secondary device 6 is in-range of the media device 8. This provides a direct communications path between the media device 8 and the user device 6. Communications between the media device 8 and the user device 6 can also be conducted via the network 2, to which both devices 6, 8 are connected. That is, in this example, two communications paths are provided between the media device 8 and the secondary device 6: one via the direct link 27; the other via the network 2. Alternatively, only one of these communications paths may be provided.

The control interface is configured to receive control signals from a dedicated controller 8C of the media device 8, such as a dedicated remote control or dedicated games controller based, for example, on infra-red, other wireless or wired communications technology. This enables the user 4 to control the media device 8 using the dedicated controller 8C by inputting user inputs to the dedicated controller 8C. Alternatively or in addition, the media device may be controlled via the short-range wireless interface 26b or even via the network interface 26a, for example using a suitable application executed on the secondary device 6 or some other user device available to the user 4.

The media controller 20 represents the core TV functionality of the media device 8. Typically the media controller 20 will be implemented by a combination of software (such as the media device's OS code) and dedicated hardware circuitry of the media device 8 (e.g. hardware digital to analogue converters, hardware audio/video codecs in some cases etc.), though alternative implementations are within the scope of this disclosure.

The media controller 20 receives AV content from the television broadcaster 17 via the AV interface 28, and processes its audio and video data as required to convert them into a form suitable for supplying to the audio and video apparatus 18A, 18B respectively. For example, the television content may be received from a satellite or cable television system to which the media device 8 is connected via the AV interface 28, or via a conventional television antenna connected to the media device via the AV interface 28. The AV content is received in digital form as a stream of data packets 25 in this example. Typically, the stream 25 contains content data packets containing audio or video data of multiple television channels in an encoded (i.e. compressed) form, based on temporal multiplexing. The AV packets of different channels are distinguished by channel identifiers in the packet headers. The stream 25 may also contain packets carrying relevant metadata e.g. program information, such as a program schedule, for the different television channels. The processing performed by the media controller 20 can include, for example:
extracting the audio/video payload data of AV packets for a television channel selected by the user 8 (i.e. the channel being watched), that the user 2 has selected using e.g. the dedicated controller 8C; decoding (i.e. decompressing) the audio and video data;
converting the extracted audio/video data into analogue audio and video signals;
supplying the analogue audio and video signals to the audio apparatus 18A and video apparatus 18B respectively.

The audio apparatus 18A comprises one or more internal loudspeakers. These may be integrated in the media device 8; external loudspeakers connected to the media device 8 using wired and/or wireless means such as free standing speakers or headphone speakers; or a combination of both. Either way, the analogue audio signals are supplied to the internal and/or external loudspeaker(s) for playing out to the user 4.

The video apparatus 18V comprises a display, such as a television screen integrated in the media device 8; one or more external displays, such as a television screen external to the media device 8 or wearable headset embodying one or more displays, using wired or wireless means; or a combination of both. Either way, the analogue video signals are supplied to the internal and/or external display(s) for displaying to the user 4.

In the case of an external loudspeaker(s)/display(s), the audio/video may instead be supplied in digital form for external conversion to analogue form, for external conversion into analogue form.

The media controller 20 can also receive and output other types of AV content to the user, such as AV content 29 received from the network 2 via the network interface 26a. The media content 29 received from the network may be streamed from the network 2 or pre-downloaded from the network 2 and stored at the media device 8 for outputting at a time of the user's choosing.

In other words, the media controller 20 is capable of receiving and outputting to the user 2 a variety of media content for consumption by the user 2, including but not limited to conventional television broadcast content and content obtained using more modern content delivery systems such as streaming and downloads.

As another example, the AV content could be stored on a separate storage medium, such as an external hard drive or DVD, from which it is retrieved by the media controller 20 and processed in a similar fashion for outputting to the user 4.

The content recognition module 22 and content engagement module 24 are software modules, which form part of the code of the client 5a (though the possibility of other implementations, such as alternative software implementations or hardware implementations, is not excluded). The client 5a runs in the background on the media device's OS so as to implement the functionality of the content recognition and engagement modules 22, 24 whilst the user 4 is consuming the outputted television content.

In whatever manner the media content is obtained and delivered to the user 2 for consumption, the content recognition module 24 is capable of identifying a portion of the media content currently being outputted to the user 2. The content portion is identified by determining a content identifier of that portion, using one or more of a variety of content recognition techniques.

For example, the content recognition module may identify a portion of the media content currently being delivered based on the audio and/or the video stream of the media content. This is known in the art as Automatic Content Recognition (ACR).

One such ACR technique is based on “watermarking”, whereby the content provider embeds a content identifier in the form of an inaudible watermark (“ACR code”) into the audio stream of the media content at different temporal points in the audio stream. In this case, the content identification database 13 stores, in association with each code, related information about the media content at that point in the media content. The content delivery module receives a version of the audio stream currently being played out by the media controller 20, and processes it to detect and extract any embedded ACR codes. An ACR code extracted by the content recognition module 22 of the media device 8 can then be used to obtain the set of content information that is associated with that ACR code in content identification database 13.

Another such ACR technique is based on “fingerprinting”, whereby a portion of the media content is identified based on its distinctive audio and/or visual characteristics. The content recognition module 22 processes the audio and/or video stream to generate its fingerprint. The fingerprint is essentially a highly compressed version of a portion of the audio/video that embodies recognizable characteristics of the audio/video, from which that portion can be identified, and is another example of a content identifier. In this case, the content database 13 holds corresponding audio/video fingerprints in associated with the associated information. A fingerprint generated by the content recognition module 22 can then be compared with the stored fingerprint to locate a matching fingerprint, and retrieve the set of content information associated with the matching fingerprint in the database 13.

As another example, alternatively or in addition, the content recognition module 22 may identify information about the content using timing information and/or metadata included in the television stream 25, or supplied with the content 29 downloaded or streamed from the network 2 etc. For example, in the case of broadcast content 25, the content recognition module can identify the content based on a current time measured at the media device 8 and a TV channel currently being watched at the media device 8. In this case, the content database 13 is organized based on the broadcast schedule, enabling a set of content information for a particular time and TV channel to be retrieved.

These examples are not exhaustive. As will be apparent, there is a variety of ways in which the content recognitions module 22 of the media device 8 can identify content attributes of a portion of the media content currently being outputted to the user 2.

Examples are presented below in which ACR codes are used for content recognition. In the following examples, the media device 8 using uses an extracted ACR code to access the content identification database 13 to retrieve the content information associated with that code. The media device 8 then stored the retrieved information as part of the user's user account data in the user account database 15, thereby making it accessible to the secondary device 6 at a later time.

The content recognitions module 24 of the media device 8 allows the user to engage with a portion of the media content currently being outputted to them using the media device, for example by inputting a user input at the dedicated controller 8C of the media device 8.

During the outputting of the media content, the content recognitions module 22 of the client 5a runs in the background on the media device 8 and processes the audio data of the media content to detect and extract any ACR codes embedded therein.

The audio and/or video data may for example be made available to the content recognition module 22 via an API (Application Program Interface) of the TV's OS.

For example, the user may be watching his favourite program/movie on the media device 8 and have the client 5a running in the background on that device 8. The client 5a is able to detect audio/video content (movies, ads, news etc.) that is being played on the media device 8 and has the intelligence to identity its content (e.g. product, celebrity, city, business etc.).

Based on the detected content, the client 5b is then able to communicate with the users' mobile device and is able to present actionable options that that the user can take on that mobile device (additionally, these actions can also be taken on the media device 8 itself). The user 4 can also share it with their contacts within the communication system.

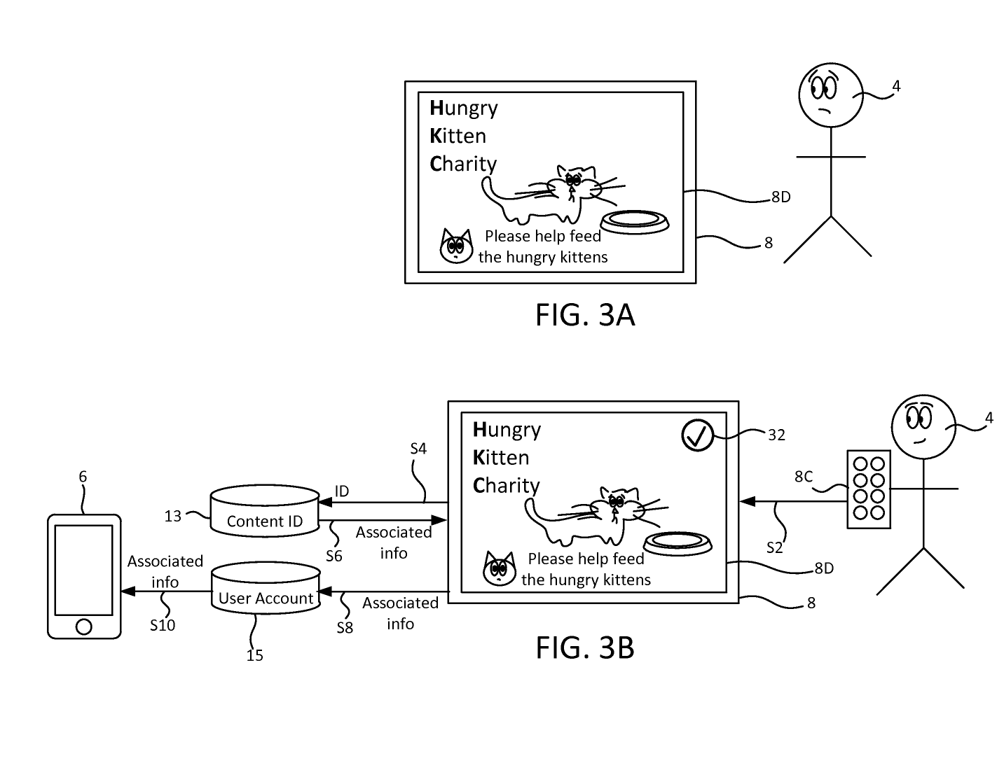

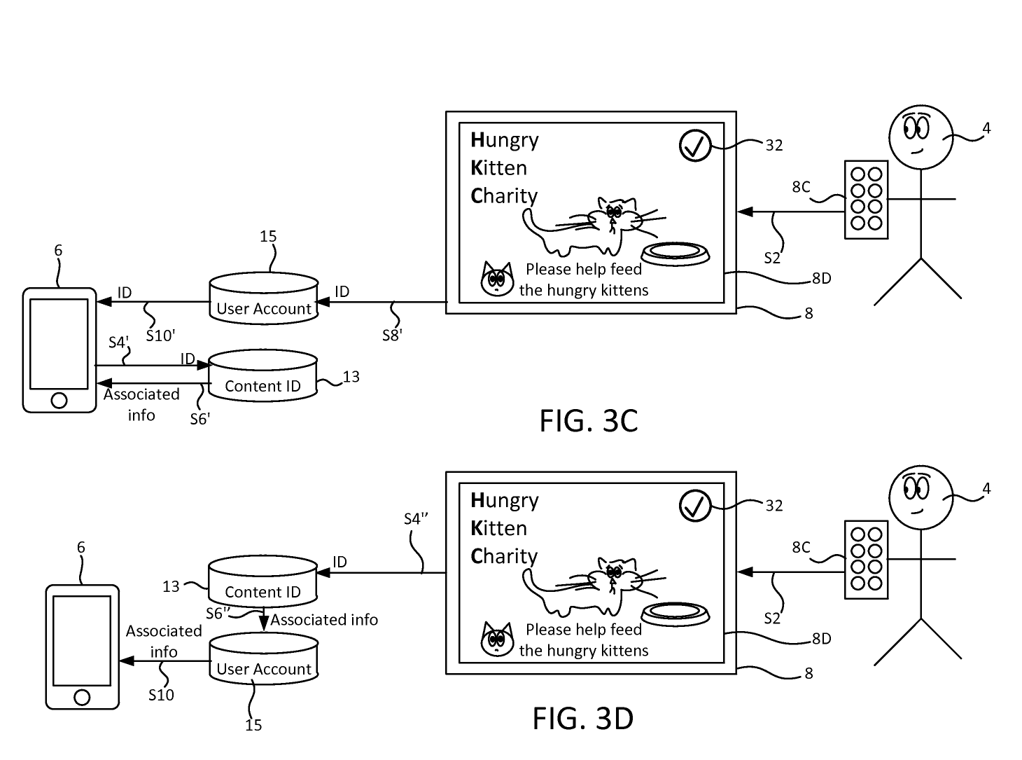

FIG. 3A shows a display 8D of the media device at a point in time during the outputting of the media content. At this point in time, the subject of the media content is a charity that is appealing for donations i.e. the portion of the media content currently being outputted contains information about the charity, in both audio and visual form, that is outputted to the user 2 by the media controller 20 of the media device 8. This portion of the media content contains an embedded ACR code, which is associated in the content identification database 13 with content information that comprises details of the charity.

The charity sparks the user's interest, so they input a user input (S2, FIG. 3B) at the dedicated controller 8C of the media device 8 to express their interest in the current portion of the media content. The user input is received by the content engagement module 24 of the media device 8, and in response to the received user input the content engagement module 24 obtains the content information associated with an extracted ACR code (“ID” in the figures) by transmitting (S4) the extracted ACR code to the content identification database 13 via the network 2 and receiving (S6) the associated content information that is returned by the content identification database 13 in response. The extracted ACR code is extracted from the current portion of the media content, which corresponds to a timing of the user input e.g. the ACR code may be the most recently extracted ACR code relative to the timing of the user input.

The associated content information may, for example, comprise a name, telephone number and/or other identifiers of the charity. The content engagement module 24 then transmits (S8) the content information received from the database 13 to the user account database 15, for storage as part of the user's user account data in the user account database 15. This means that, at a later time of the user's choosing, they can access (S10) the stored content information using their user device 6 when logged in at their secondary device 6 to the remote computer system 14.

Alternatively or in addition, as illustrated in FIG. 3C, the media device 18 may transmit the ACR code itself to the user account database 15 (S8′) for storage as part of the user's account data. The secondary device 6 can then access (S10′) the stored ACR code when logged in to the remote system 14, and retrieve the associated content information from the content identification database 13 itself (S4′, S6′).

Alternatively or in addition, as illustrated in FIG. 3D, the media device 8 may transmit the ACR code to the content identification database 13 (S4″) in a message that identifies where in the user account database 15 the user's user account data is held. In this case, the content identification database 13 itself transmits (S6″) the associated content information to the user account database 15 for storing as part of the user's identified account data, so that the user device 6 can then retrieve it from the user account database 15 (S10, as above).

The media device 8 able to modify the user's account data in the user account database 15 (as in the embodiments of FIGS. 3A and 3B), or to authorize the content identification database 13 to modify this data (as in the embodiment of FIG. 6C), because it is logged in to the remote computer system 14 using the user's login credentials.

As shown in FIGS. 3B-3D, an icon 32 or other suitable notification may be briefly displayed on the display 8D of the media device 8 to indicate that the content attribute information has been successfully transmitted. The icon 32 is displayed for a short time (e.g. a few seconds) in a non-intrusive manner (e.g. near a corner of the display 8D, occupying only a small portion of the available display area), so as not to disrupt the user's viewing experience.

In some embodiment, the media device 8 may also display an option that is selectable to display the retrieved information on the media device 8 itself.

Whilst the above has been described in relation to ACR codes, it will be appreciated that the same techniques can be applied to other types of content identifier, such as ACR fingerprints, timestamps, metadata etc. to achieve the same result. Thus, all of the description pertaining to ACR codes herein can be applied equally to other types of content identifier.

Where available, the direct communications link 27 may be used to transmit the desired information (i.e. the content identifier and/or associated content information) to the secondary device 6 directly 6, as an alternative or in addition to storing it in the user account database 15. Alternatively, the information could be transmitted to the user device via, say, a local WiFi network or other local network, or via the Internet 2 by some other means. In the embodiment of FIG. 3C, the message may identify the secondary device 6 itself (e.g. based on its network address, or the user's username that is associated with the secondary device 6 within the communication system 1) so that the content identification server 13 can transmit the associated information to the secondary device 6 directly.

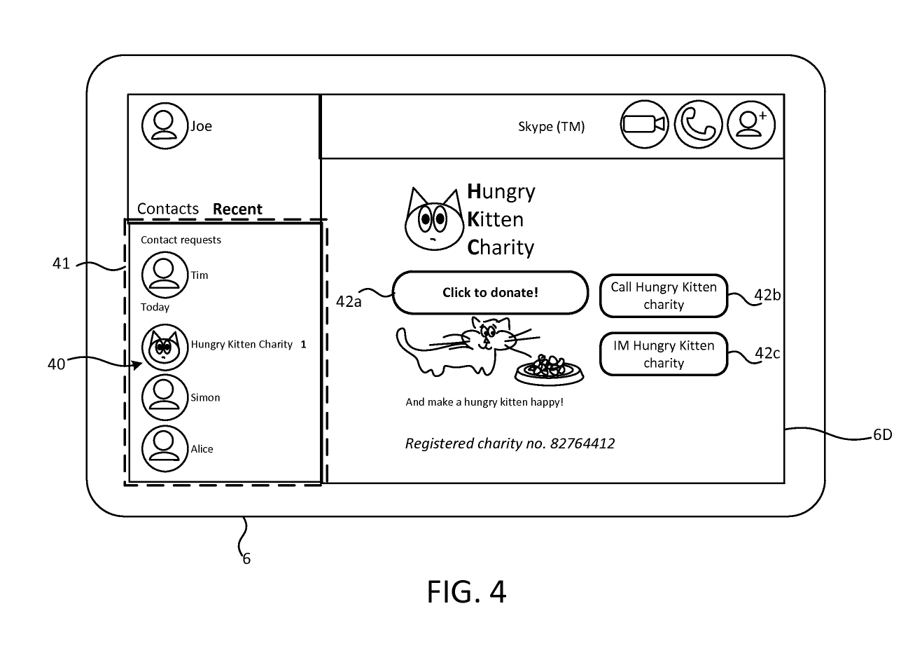

FIG. 4 shows a display 6D of the secondary device, on which a graphical user interface (UI) of the communication client 5b is displayed.

Once the secondary device 8 has retrieved the content information from the user account database 15 or the content identification server 13 as applicable, it can display on the display 6D a display element 40 representing the content information (representing the charity in this example).

In the embodiment illustrated in FIG. 4, the display element is a selectable notification 40 that is displayed in a notification area 41 of the display 6D, i.e. an area reserved for display notifications, along with other notifications of recent events, such as contact requests from other users of the communication system, communication events recently conducted with other users of the communication system, and recently added contacts of the user 2.

In response to the user 2 selecting the selecting the notification 40 representing the charity, additional information about the charity is displayed on the display 6D, such as its name, logo, registered charity number, associated graphics, slogans etc. Additional selectable display elements 42a-42c are also displayed. These are selectable to donate to the charity (42a) using the client application 5b, call the charity (42b) using the client 5b, and initiate an instant messaging (IM) session with the charity (42c) using the client 5b. The additional information may for example be part of the retrieved content information itself, or the retrieved content information may comprise a link (e.g. URI) to this additional information what can be used to retrieve it.

As another example, an advertisement may be displayed up during an advertisement break in television content. The advert is for a new pizza company that's offering a promotion for sales. The pizza company has previously registered an ACR code embedded in the audio of the advertisement with the content identification database 13.

Now when the pizza advertisement is played, the content recognition module 22 of the background app 5a on the media device 8 detects the inaudible ACR code. The ACR code is used to query the content identification database 13. The content identification database holds more localised and personalized information about the pizza company in association with the ACR code, which it returns to the client 5a on the media device 8 in response (e.g. money saving offers, contact info etc.).

The user 2 can then select an option at the media device 8 for this information to be sent to his secondary device 6, or the information may be send to the secondary device automatically. In addition, the user 6 may be presented with an option of viewing the information on the media device 8 itself.

At a later time, the user 2 can order a pizza from his secondary device 6, using payment credits associated with his user account within the communication system. The client 5b on the secondary device app to deduct the funds from the credit account. The user account data of the user 2 in the user account database 15 contains details of the user 2, including a postal address of the user 2, which the user has previously registered within the communication system. This means that the client 5b on the secondary device can supply the user's pre-registered address to the pizza company (with the user's permission) to save the user entering their address again, so that they can deliver the pizza to that address. The user's details stored at the user account database 15 also contain a preregistered email address of the user 2, which is used to send a receipt for the pizza to the user.

The user 2 can also go “back in time” and get information about any adverts that were displayed in the past, and which they flagged using a user input at the media device 8. E.g. If the pizza advert originally played the user 2 was not hungry, it may be a few hours later that he is thinking about the pizza advert and remembers that he had seen a great deal. Because the pizza company info is stored as part of the user's account data, they can easily to use the client 5b on their secondary device to retrieve it at that time.

According to a first aspect of the present subject matter, a media device comprises: a media output configured to connect to media output apparatus; a media input configured to receive media content; a media controller configured to output the media content to a user via the media output apparatus; a control input configured to receive from the user a user input during the outputting of the media content, the user input denoting a current interest in the media content expressed by the user; a content recognition module configured to determine an identifier of a portion of the media content corresponding to a timing of the user input, the identifier for locating associated content information held in a content identification database; and a content engagement module configured, in response to the user input being received at the media device, to use the identifier to render accessible, to a secondary device available to the user, the associated content information.

In embodiments, the content engagement module may be configured to render available to the secondary device the associated content information by: transmitting the identifier to the content identification database, receiving, from the content identification database, the associated content information, and transmitting the associated content information to the secondary device and/or to a remote memory location accessible to the secondary device for storing thereat.

Alternatively or in addition, the content engagement module may be configured to render available to the secondary device to the associated content information by: transmitting the identifier to the secondary device and/or to a remote memory location accessible to the secondary device for storing thereat, so that the secondary device can use the identifier to retrieve the associated content information from the content identification database.

Alternatively or in addition, the content engagement module may be configured to render available to the secondary device to the associated content information by: transmitting the identifier to the content identification database in a message that identifies the secondary device and/or a remote memory location accessible to the user device, so as to cause the content identification database to transmit the associated content information to the secondary device and/or to the remote location.

In some cases, the media device may be configured to receive login credentials from the user via the control input, log in to a remote computer system using the login credentials, thereby gaining access to the remote memory location, and cause the identifier and/or the associated information to be stored at the remote memory location whilst logged in to the remote computer system; whereby the identifier and/or the content information stored at the remote memory location is accessible to the secondary device when the secondary device is logged in to the remote computer system using the same login credentials.

The media device may comprise a processor, the content recognition and engagement modules may be code modules a communication client for effecting communication events via the network and the processor may be configured to execute the communication client.

The identifier of the media content may comprise:
an inaudible code extracted from audio data of the portion of the media content by the content recognition content,
a fingerprint of the portion of the media content generated, by the content recognition module, by processing the portion of the media content,
a timestamp identifying a timing of the portion of the media content,
a channel identifier of a television channel broadcasting the media content, and/or
metadata received with the media content.

The associated information may comprise information about an entity appearing in and/or described by the portion of the media content

The media device may, for example, be a television, set-top box, or games console. In some such cases, the user input may be inputted by the user using a dedicated remote control or dedicated game controller of the media device.

According to a second aspect of the present subject matter, a method of identifying a portion of media content being outputted to a user by a media device comprises: during the outputting of the media content, receiving from the user at the media device a user input, wherein the user input denotes a current interest in the media content expressed by the user; and determining by the media device an identifier of a portion of the media content corresponding to a timing of the user input, the identifier for locating associated content information held in a content identification database; wherein, in response to the user input, the media device uses the identifier to render accessible, to a secondary device available to the user, the associated content information.

In embodiments, the method may further comprise: accessing, by the secondary device, the associated content information rendered accessible to the secondary device by the media device; controlling, by the secondary device based on the associated content information, a display of the secondary device to display a display element representing the associated content information.

For example, the accessing and controlling steps may be performed by code executed on a processor of the secondary device e.g. code that forms part of a communication client executed on the secondary device for effecting communication events via the network.

In some cases, the communication client may control the display to display at least one notification in a notification area of the display, wherein the at least one of the notifications represents:
a contact of the user,
a contact request sent to the user from another user,
a communication event previously conducted between the user and another user.
   The display element that represents the content information may also be a notification that is displayed in the notification area of the display by the communication client.

The media device may receive login credentials from the user, log in to a remote computer system using the login credentials, thereby gaining access to the remote memory location, and causes the identifier and/or the associated information to be stored at the remote memory location whilst logged in to the remote computer system. The secondary device may receive the same login credentials from the user, and log in to the remote computer system using the login credentials so as to gain access to the associated content information for outputting to the user. In some cases, the secondary device may not be logged in when the identifier and/or the associated content information is stored at the remote memory location (though in other cases it may be).

The associated content information may identify an entity appearing in and/or described by the portion of the media content, and the display element may be an option selectable by the user at the secondary device to:
initiate a communication event between the user and the entity using the secondary device,
initiate a payment procedure so as to effect a payment to the entity using credit that is electronically stored within the communication system in association with a user account of the user, or
transmit details of the user that are stored within the communication system to the entity.

The secondary device may, for example, be a smartphone, tablet, laptop computer, or desktop computer.

In a third aspect of the present subject matter, a computer program product comprises code stored on a computer readable storage medium and configured to implement any of the method steps and/or device functionality disclosed herein when executed on a computer.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the media device or secondary device may also include an entity (e.g. software) that causes hardware of the device to perform operations, e.g., processors functional blocks, and so on. For example, the devices may include a computer-readable medium that may be configured to maintain instructions that cause the devices, and more particularly the operating system and associated hardware of the devices to perform operations. Thus, the instructions function to configure the operating system and associated hardware to perform the operations and in this way result in transformation of the operating system and associated hardware to perform functions. The instructions may be provided by the computer-readable medium to the devices through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A media device comprising:
a media output configured to connect to media output apparatus;
a media input configured to receive media content;
a media controller configured to output the media content to a user via the media output apparatus;
a control input configured to receive from the user a user input during the outputting of the media content, the user input denoting a current interest in the media content expressed by the user;
a content recognition module configured to determine an identifier of a portion of the media content corresponding to a timing of the user input, the identifier for locating associated content information held in a content identification database; and
a content engagement module configured, in response to the user input being received at the media device, to use the identifier to render accessible, to a secondary device available to the user, the associated content information.

2. A media device according to claim 1, wherein the content engagement module is configured to render available to the secondary device the associated content information by:
transmitting the identifier to the content identification database,
receiving, from the content identification database, the associated content information, and
transmitting the associated content information to the secondary device and/or to a remote memory location accessible to the secondary device for storing thereat.

3. A media device according to claim 1, wherein the content engagement module is configured to render available to the secondary device to the associated content information by:
transmitting the identifier to the secondary device and/or to a remote memory location accessible to the secondary device for storing thereat, so that the secondary device can use the identifier to retrieve the associated content information from the content identification database.

4. A media device according to claim 1, wherein the content engagement module is configured to render available to the secondary device to the associated content information by:
transmitting the identifier to the content identification database in a message that identifies the secondary device and/or a remote memory location accessible to the user device, so as to cause the content identification database to transmit the associated content information to the secondary device and/or to the remote location.

5. A media device according to claim 2, which is configured to receive login credentials from the user via the control input, log in to a remote computer system using the login credentials, thereby gaining access to the remote memory location, and cause the identifier and/or the associated information to be stored at the remote memory location whilst logged in to the remote computer system;
whereby the identifier and/or the content information stored at the remote memory location is accessible to the secondary device when the secondary device is logged in to the remote computer system using the same login credentials.

6. A media device according to claim 1, which comprises a processor, wherein the content recognition and engagement modules are code modules a communication client for effecting communication events via the network and the processor is configured to execute the communication client.

7. A media device according to claim 1, wherein identifier of the media content comprises:
an inaudible code extracted from audio data of the portion of the media content by the content recognition content,
a fingerprint of the portion of the media content generated, by the content recognition module, by processing the portion of the media content,
a timestamp identifying a timing of the portion of the media content,
a channel identifier of a television channel broadcasting the media content, and/or
metadata received with the media content.

8. A media device according to claim 1, wherein the associated information comprises information about an entity appearing in and/or described by the portion of the media content

9. A media device according to claim 1, which is a television, set-top box, or games console.

10. A media device according to claim 9, wherein the user input is inputted by the user using a dedicated remote control or dedicated game controller of the media device.

11. A method of identifying a portion of media content being outputted to a user by a media device, the method comprising:
during the outputting of the media content, receiving from the user at the media device a user input, wherein the user input denotes a current interest in the media content expressed by the user; and
determining by the media device an identifier of a portion of the media content corresponding to a timing of the user input, the identifier for locating associated content information held in a content identification database;
wherein, in response to the user input, the media device uses the identifier to render accessible, to a secondary device available to the user, the associated content information.

12. A method according to claim 11, further comprising:
accessing, by the secondary device, the associated content information rendered accessible to the secondary device by the media device;
controlling, by the secondary device based on the associated content information, a display of the secondary device to display a display element representing the associated content information.

13. A method according to claim 12, wherein the accessing and controlling steps are performed by code executed on a processor of the secondary device.

14. A method according to claim 13, wherein the code forms part of a communication client executed on the secondary device for effecting communication events via the network.

15. A method according to claim 14 wherein the communication client controls the display to display at least one notification in a notification area of the display, wherein the at least one of the notifications represents:
a contact of the user,
a contact request sent to the user from another user,
a communication event previously conducted between the user and another user;
wherein the display element that represents the content information is also a notification that is displayed in the notification area of the display by the communication client.

16. A method according to claim 11, wherein the media device receives login credentials from the user, logs in to a remote computer system using the login credentials, thereby gaining access to the remote memory location, and causes the identifier and/or the associated content information to be stored at the remote memory location whilst logged in to the remote computer system;
wherein the secondary device receives the same login credentials from the user, and logs in to the remote computer system using the login credentials so as to gain access to the associated content information location for outputting to the user.

17. A method according to claim 16, wherein the secondary device is not logged in when the identifier and/or the associated content information is stored at the remote memory location.

18. A method according to claim 14, wherein the associated content information identifies an entity appearing in and/or described by the portion of the media content, and the display element is an option selectable by the user at the secondary device to:
initiate a communication event between the user and the entity using the secondary device,
initiate a payment procedure so as to effect a payment to the entity using credit that is electronically stored within the communication system in association with a user account of the user, or
transmit details of the user that are stored within the communication system to the entity.

19. A method according to claim 11, wherein the secondary device is a smartphone, tablet, laptop computer, or desktop computer.

20. A computer program product comprising code stored on a computer readable storage medium and configured to implement the method according to claim 11 when executed on a computer.
